(19) United States
(12) Patent Application Publication
(10) Pub. No.: US 2007/0046047 A1
(43) Pub. Date: Mar. 1, 2007

(54) Device for carrying panel-like flat sheets

(76) Inventor: Walter Ehrhardt, Wilmington, DE (US)

Correspondence Address: EDWIN TARVER, 16830 Ventura Blvd., SUITE 360, Encino, CA, 91436, US

(21) Appl. No.: 11/510,296

(22) Filed: Aug. 25, 2006

Related U.S. Application Data
(60) Provisional application No. 60/711,250, filed on Aug. 25, 2005.

(51) Int. Cl. B65G 7/12

(52) U.S. Cl. 294/15

(57) ABSTRACT

A carrying device for flat, panel-like objects. The device is a unitary construction comprising a pair of spaced apart straight legs connected by a cross bar at their top ends and a pair of panel supporting members. Each of the panel supporting members extends from a bottom end of the leg and is curved upwards. The external surface of the device includes multiple circumferential ridges that help provide a good grip.

### CROSS-REFERENCE TO RELATED APPLICATION

This application claims the priority of provisional application No. 60/711250, filed on Aug. 25, 2005.

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The present invention relates in general to carrying devices, and more particularly to devices for carrying flat panel-like objects.

Flat panel-like objects such as plywood sheets, drywall panels, and doors are inconvenient to handle due to their size and shape. Persons carrying such objects find them difficult to carry, particularly when climbing stairs.

Several devices for carrying flat panel-like objects have been developed in art. U.S. Pub. No. 5,318,316 to Shurtleff discloses a cart for carrying doors, plywood and drywall sheets, mirrors, and other panel-like objects. The cart comprises a mobile chassis having wheels, cooperating fixed and movable jaws and a removable handle. A panel like object is securely clamped between fixed and movable jaws in the process of loading it into the cart. The object is released from the jaws when it is lifted upwardly to remove it from the cart. This cart is not suitable for carrying large panel like objects up and down stairs.

U.S. Pat. No. 4,190,278 to Jancik, Jr. discloses a panel carrying device that comprises pair of curved arms connected by two bars. The arms include panel supporting ends at their lower free ends. The arms are curved throughout their length and have a change in the curve near their lower ends. Either of the two bars can be used as a handle. The curved arms allow the panel carrying device to rock and pivot upwardly when a panel is placed on it.

U.S. Pat. No. 2,430,142 to Roberts discloses a device that is adjustable to various lengths for carrying panel like objects. The device comprises a hand grip, two legs extending downwardly from the handle and a carrying space continuous with the lower ends of the two legs. Objects such as panes of glass, boards and the like are received in the carrying space. The legs are turned inwardly at their upper ends for insertion into a bore of the hand grip. The legs are divided into two parts and the ends of these parts are inserted into a tube provided with set screws for locking the two parts in any adjustable position within the tube. However, Jancik and Roberts are different in construction compared to the present invention.

U.S. Pat. No. 2,623,772 to Johnson discloses a hay tool comprising a pair of spaced, curved tines having generally parallel shank portions, an integral cross-bar joining the shank portions together at their root ends, and a second cross-bar affixed between the shank portions in spaced parallel relation to the integral cross-bar. Both the cross-bars may be grasped simultaneously in the hand of a user. The tines are bent in approximately a semi-circle with their outer ends sharpened to pointed ends. This device is not suitable for holding panels, and the pointed ends and smooth body are different from the present invention.

The object of the present invention is to provide a device for carrying flat, panel-like objects that is simple in construction, easy to manufacture, and convenient to handle. The device of the present invention also aims at improving gripping features for safely carrying flat panel-like objects. Other objects of the present invention will become better understood with reference to the appended Summary, Description, and Claims.

### SUMMARY

The present invention is a device for carrying flat panel-like sheets. The design of the device enables a user to easily carry flat panel-like objects in any direction. The device is comprised of a unitary piece and can be easily made by bending a metal rod. The device comprises a pair of legs, a cross bar connecting top ends of the legs and a pair of panel supporting members extending from bottom ends of each of the legs. The panel supporting members are curved upwards to form a hook like structure at the bottom of the legs for receiving a panel. The connections between the cross bar, the legs and the panel supporting members can be curved.

### BRIEF DESCRIPTION OF THE FIGURES

FIG. 1 is a perspective view of the device of the present invention.

FIGS. 2 and 3 illustrate the device of the present invention being in use.

FIG. 4 is a side view of the device of the present invention.

### FIGURES—REFERENCE NUMERALS

10 . . . Device of the Present Invention
11 . . . Leg
12 . . . Cross Bar
13 . . . Panel Supporting Member
14 . . . Circumferential Ridge
15 . . . Panel
16 . . . User

### DETAILED DESCRIPTION

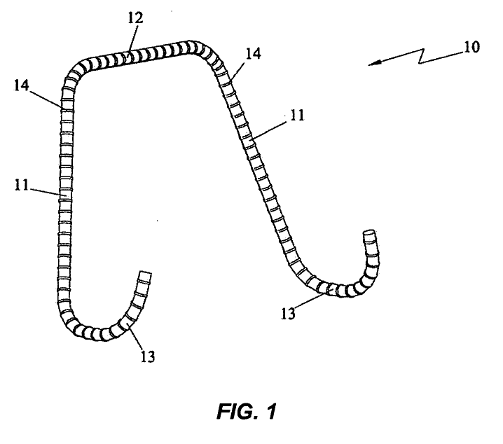

Referring to the drawings, a preferred embodiment of a device for carrying panel like objects is illustrated and generally indicated as 10 in FIGS. 1 through 4. The device comprises a pair of straight legs 11, a cross bar 12 and a pair of panel supporting members 13.

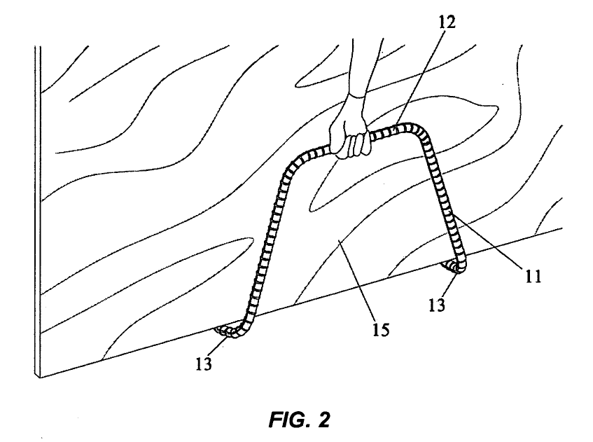

Referring to FIGS. 1 and 2, the cross bar 12 connects the top ends of the legs 11. The legs 11 are not parallel and maintain an angle slightly more than 90 degrees with respect to the cross bar 12. The cross bar 12 is used to grasp the device. Each panel supporting member 13 extends from the bottom end of the leg and curved upwards to form a hook type structure. However, slight variations in the design of the panel supporting members 13 are possible as long as the members 13 terminate in a hook-like structure.

The legs, cross bar and panel supporting members have uniform cross-sectional area, and in one preferred embodiment are of circumferential cross-section. In another preferred embodiment, the exterior surfaces of the device 10 include multiple circumferential ridges 14 throughout its entire length. The ridges 14 facilitate in maintaining a firm grip while using the device 10 to carry flat panel-like objects.

The connections between the cross bar and the legs may form rounded corners, and the connections between the panel supporting members and the legs may be curved without any sharp corners as well. The device 10 can be made by bending a metal rod. Alternatively, molding techniques can also be used to manufacture the device.

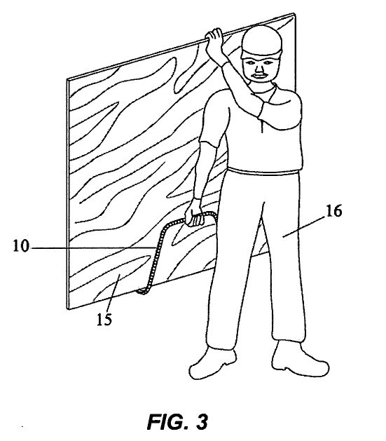

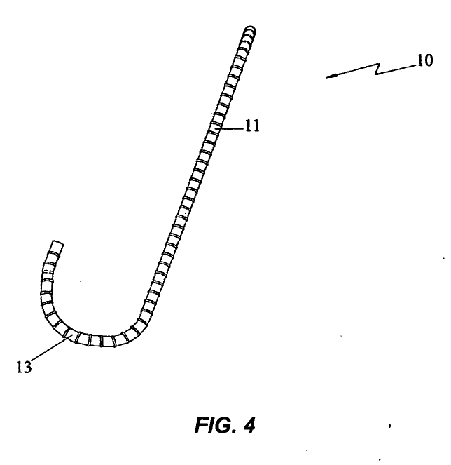

Referring to FIGS. 3 and 4, in order to use the device 10, a panel 15 is made to rest on the inside portion of the panel supporting member 13. A user 16 can then lift the device 10 along with the panel 15 by grasping the cross bar 12 with one hand and balancing the panel 15 with the other. If the panel is too large, then two users employing two devices can carry it. The circumferential ridges 14 hinder movement of the panel while carrying, making the device 10 more convenient to use.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. § 112, paragraph 6. In particular, the use of “step of” in the claims herein is not intended to invoke the provisions of 35 U.S.C. § 112, paragraph 6.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. A device for carrying panel like flat objects, the device comprising:
a) a pair of spaced apart straight legs having top and bottom ends;
b) a cross bar connecting the top ends of the legs, the cross bar acting as a handle when using the device;
c) a pair of panel supporting members, each extending from the bottom end of each of the legs and curved upwards resulting in a hook type or U-shaped structure at the bottom of the leg, the connections between the legs and the panel supporting members being curved without pointed corners; and

2. The device of claim 1, wherein a multiplicity of circumferential ridges are disposed on the external surfaces of the legs, the panel supporting members, and the cross bar.

3. The device of claim 1, wherein the connection between the cross bar and the legs form rounded corners.

4. The device of claim 1, wherein the legs, the panel supporting members, and the cross bar comprise same cross-sectional area.

5. The device of claim 1, wherein the distance between the top ends of the legs is slightly less than the distance between the bottom ends such that the angle
between the cross bar and each of the legs is more the 90 degrees.

6. The device of claim 1, wherein the device is a unitary piece.

7. The device of claim 1, wherein the device is made of metal.

8. The device of claim 1, wherein the device is made of rigid materials.
